(19) United States
(12) Patent Application Publication
(10) Pub. No.: US 2012/0298875 A1
(43) Pub. Date: Nov. 29, 2012

(54) Radiation Measurement Apparatus and Method of Measuring Radiation

(75) Inventors: Katsunori UENO, Hitachi (JP); Takahiro Tadokoro, Hitachi (JP); Hiroshi Kitaguchi, Naka (JP); Mizuho Tsuyuki, Tsuchiura (JP); Nobuyuki Ota, Hitachi (JP); Makoto Nagase, Mito (JP)

(73) Assignee: Hitachi, Ltd., Tokyo (JP)

(21) Appl. No.: 13/456,629

(22) Filed: Apr. 26, 2012

(30) Foreign Application Priority Data
Apr. 28, 2011 (JP) 2011-100824

(51) Int. Cl. G01T 1/36

(52) U.S. Cl. 250/362; 250/336.1; 250/369; 250/370.01; 250/395; 250/371

(57) ABSTRACT

In a radiation measurement apparatus, an analog pulse signal output from a semiconductor radiation detector is converted to a plurality of digital signals by an analog-to-digital converter for each analog pulse signal. A threshold circuit for inputting these digital signals discriminates digital signals exceeding a threshold value. A digital signal integration circuit integrates the plurality of discriminated digital signals for each analog pulse signal and obtains an integrated value for each analog pulse signal. A spectrum generation circuit for inputting the respective integrated values generates a radiation energy spectrum using the integrated values and accurately performs the quantitative analysis and energy analysis of a radioactive nuclide using the radiation energy spectrum. A quantitative analysis and an energy analysis of a radioactive nuclide can be accurately performed while a time resolution of a radiation detector can be maintained.

### CLAIM OF PRIORITY

The present application claims priority from Japanese Patent application serial no. 2011-100824, filed on Apr. 28, 2011, the content of which is hereby incorporated by reference into this application.

### BACKGROUND OF THE INVENTION

1. Technical Field

The present invention relates to a radiation measurement apparatus and a method of measuring radiation and more particularly to a radiation measurement apparatus and a method of measuring radiation that are suitable for generating a radiation energy distribution based on a pulse signal output from a radiation detector and analyzing a radioactive nuclide.

2. Background Art

One of the methods for analyzing a radioactive nuclide uses a radiation measurement apparatus having a radiation detector and a radiation measurement circuit, measures radiation energy radiated from the radioactive nuclide by the radiation detector, and identifies and determines the quantity of the radioactive nuclide by the radiation measurement circuit. Concretely, to measure the radiation energy, radiation is converted to a signal of charges by a general-purpose radiation detector such as a NaI (TI) scintillation detector and a Ge (Li) semiconductor detector, and by using a photomultiplier, a charge sensitive amplifier, a pulse shaper, a digital signal processing (DSP) applying a trapezoidal filter and a general-purpose radiation measurement circuit such as a multi channel pulse height analyzer (MCA), a radiation energy distribution is generated, thus a radiation energy analysis is executed.

In nuclear power facilities, medical facilities using an accelerator or a radioactive isotope, research accelerator facilities, and a cosmic environment, there are states and places that the environmental dose rate becomes a very high level. As an example, in the nuclear power facilities, the place that the environmental dose rate becomes a very high level is inside of a primary containment vessel when a nuclear power plant is in operation. In the medical facilities, the places are a beam irradiation room and a radioactive isotope use room when the accelerator is in operation. The cosmic environment is a very high dose field compared with on the ground.

Monitoring of the dose or a radioactive nuclide in these environments is executed in real time. The reason is that for example, in the nuclear power facilities, a radiation measurement apparatus capable of quickly detecting a leak of the radioactive nuclide, for both of a high counting rate and a high dose rate, is necessary in order to ensure the safety of the nuclear power facilities. Further, in the medical facilities, radiation irradiation to a patient of proton therapy and giving of a radioactive medicine to a patient of a positive electron tomography (PET) are executed.

An example of the radiation measurement apparatus is described in Japanese Patent Laid-open No. 8 (1996)-189974 and Japanese Patent Laid-open No. 2002-55171.

The radiation measurement apparatus described in Japanese Patent Laid-open No. 8 (1996)-189974 has a radiation detector for generating charges in correspondence to incident radiation and further has a preamplifier, a signal detector, a lamp signal generator, a signal processor, and a spectrum display apparatus. The preamplifier converts the charge amount generated by the radiation detector to an electric signal and outputs the electric signal. The signal detector detects the output signal of the preamplifier and when the signal detector detects the output signal, the lamp signal generator generates a predetermined lamp signal. An adder adds the output signal of the preamplifier to the lamp signal and an analog-to-digital converter (hereinafter, referred to as an A/D converter) converts an addition result obtained by the adder to a digital signal by analog-to-digital conversion. The signal processor time-averages an integral value obtained by integrating a digital value that is an output of the A/D converter and converts the time mean value to channel. This radiation measurement apparatus can obtain a radiation energy spectrum easily and precisely.

Japanese Patent Laid-open No. 2002-55171 describes a radiation measurement apparatus. The radiation measurement apparatus is provided with a semiconductor radiation detector, a preamplifier, a pulse shaper, a bandpass filter, a peak detection circuit, a peak hold circuit, an A/D converter, and a multi-channel analyzer (MCA). The pulse shaper includes an differential circuit, an amplifier, and an integrator that are connected in series.

The preamplifier integrates a minute charge pulse that is a radiation detection signal output from the semiconductor detector for detecting the radiation and converts and amplifies it to a voltage pulse. A differential circuit shortens damping time of the voltage pulse and the amplifier amplifies an output signal of the differential circuit and shapes the pulse waveform. The integrator shapes the output waveform of the amplifier to a pulse waveform in a Gauss function shape. The bandpass filter emphasizes and takes out a signal generated based on a radiation detection signal from the output waveform of the amplifier. The peak detection circuit extracts signals of a threshold value or higher among signals output from the bandpass filter. The peak hold circuit peak-holds the output signal output from the integrator and shaped to the pulse waveform in the Gauss function shape, by the signal output from the peak detection circuit. The A/D converter converts the peak value of the signal peak-held by the peak hold circuit from analog to digital by a timing signal from the peak detection circuit, and thereby converts it to a digital signal. The MCA statistically analyzes the digital signal and executes a multi-channel peak analysis and time distribution measurement.

Japanese Patent 2577386 describes a radiation energy spectrum measurement apparatus for obtaining a radiation energy spectrum based on an output signal of the radiation detector.

### CITATION LIST

### Patent Literature

[Patent Literature 1] Japanese Patent Laid-open No. 8 (1996)-189974
[Patent Literature 2] Japanese Patent Laid-open No. 2002-55171
[Patent Literature 3] Japanese Patent 2577386

### SUMMARY OF THE INVENTION

### Technical Problem

To easily execute a quantitative analysis and an energy analysis of a radioactive nuclide in real time using the radiation measurement apparatus having the general purpose radiation detector and the radiation measurement circuit, it is necessary to set an upper limit of a maximum counting rate of the radiation measurement apparatus to about 10⁴ to 10⁵ count per second (cps) and execute measurement and analysis. A range of the maximum counting rate depends on the radiation detector and radiation measurement circuit that are used. However, the latter radiation measurement circuit processes the radiation detection signal for deteriorating the time resolution (for example, in the scintillator, the light emission damping time and in the semiconductor radiation detector, the electron collection time) of the radiation detector, in contrast to improvement of the S/N ratio in the signal processing. Therefore, in the conventional radiation measurement apparatus, the time resolution of the radiation detector is deteriorated and to execute radiation measurement and analysis within the range exceeding the maximum counting rate, pile-up and counting loss of the signal components becomes worse and in the radiation measurement in real time, the measurement accuracy cannot be maintained.

The radiation measurement apparatus described in Japanese Patent Laid-open No. 2002-55171 decides peak detection, that is, a detection threshold value using a signal branching in the output portion of the amplifier of the pulse shaper to effectively measure the low energy component. This apparatus is characterized in that the low energy component can be measured due to the accuracy improvement of the detection threshold value and it is not a throughput counting rate improvement apparatus aiming at all the energy. Namely, the maximum counting rate of the radiation measurement apparatus is about 10⁵ cps.

The radiation energy spectrum measurement apparatus described in Japanese Patent 2577386 is an apparatus for operating a germanium semiconductor detector at a high energy resolution. Japanese Patent 2577386 includes no description of improvement of the throughput.

The energy spectrum measurement apparatus described in Japanese Patent Laid-open No. 8 (1996)-189974, to reduce conversion errors of the A/D converter, uses that if the errors of all the channels are added, the errors become zero as a whole. Therefore, a preamplifier signal input to the adder must be set to a fixed output with an amplitude P that is shown as an example in Japanese Patent Laid-open No. 7 (1995)-2919, thus the time resolution of the radiation detector is deteriorated. Therefore, the maximum counting rate has a limit of about 10⁵ cps.

If the upper limit of the maximum counting rate restricted in the radiation measurement apparatus can be increased, the time resolution of the radiation detector can be utilized and even in the environment of a high dose rate and a high counting rate, the quantitative analysis and energy analysis of radiation can be easily executed in real time. Furthermore, thickness of a radiation shielding body of the radiation measurement apparatus can be decreased and the compactness and reduction in weight of the radiation measurement apparatus including the radiation shielding body can be realized. Furthermore, in correspondence to the performance maintenance at a high counting rate, it can be used as a high-speed radiation monitoring apparatus and radiation measurement apparatus, so that the radiation measuring time can be shortened.

An object of the present invention is to provide a radiation measurement apparatus and a method of measuring radiation capable of accurately performing the quantitative analysis and energy analysis of a radioactive nuclide while maintaining time resolution of a radiation detector.

### Solution to Problem

A feature of the present invention for accomplishing the above object is a radiation measurement apparatus comprising a radiation detector for detecting radiation and outputting an analog pulse signal that is a radiation detection signal; an analog-to-digital converter for converting the analog pulse signal to a plurality of digital signals for each analog pulse signal output from the radiation detector; a digital signal integration apparatus for integrating the plurality of digital signals output from the analog-to-digital converter for each analog pulse signal and obtaining an integrated value for each analog pulse signal; and a spectrum generation apparatus for generating a radiation energy spectrum using the integrated values and performing the quantitative analysis and energy analysis of a radioactive nuclide discharging the radiation that is detected by the radiation detector using the information of the radiation energy spectrum.

The analog pulse signal is converted to a plurality of digital signals for each analog pulse signal output from the radiation detector, and an integrated value is obtained for each analog pulse signal by integrating the plurality of digital signals for each analog pulse signal, and a radiation energy spectrum is generated using the integrated values, so that the radiation energy information included in each analog pulse signal output from the radiation detector can be obtained while the time resolution of the radiation detector is maintained, thus by use of the radiation energy information, information of the radiation energy spectrum can be prepared in real time, and the quantitative analysis and energy analysis of a radioactive nuclide discharging radiation can be accurately performed.

The background art performs an energy analysis by the peak hold circuit having a longer time resolution than that of the analog pulse signal input, so that dead time is caused and the throughput is suppressed. On the other hand, in the present invention, the analog pulse signal is converted to a plurality of digital signals, which are digitally integrated, so that the throughput of the radiation detector can be utilized (for example, utilized at its maximum) while the time resolution of the radiation detector can be maintained.

### Advantageous Effect of the Invention

According to the present invention, the quantitative analysis and energy analysis of a radioactive nuclide can be performed accurately while the time resolution of the radiation detector can be maintained.

### BRIEF DESCRIPTION OF THE DRAWINGS

FIG. 1 is a structural view showing a radiation measurement apparatus according to embodiment 1, which is a preferred embodiment of the present invention.

FIG. 2 is an explanatory drawing showing an example of pulse signal that is a radiation detection signal output from a radiation detector shown in FIG. 1.

FIG. 3 is an explanatory drawing showing an example of pulse signal shown in FIG. 2 that is converted to digital by an analog-to-digital converter shown in FIG. 1.

FIG. 4 is an explanatory drawing showing an example of a method of integrating pulse signal after digital conversion in a digital signal integration circuit shown in FIG. 1.

FIG. 5 is an explanatory drawing showing the number of sample points integrated in the integration process in a digital signal integration circuit in one pulse of a pulse signal that is a radiation detection signal output from a radiation detector.

FIG. 6 is an explanatory drawing showing an example of a radiation energy spectrum generated by a spectrum generation circuit shown in FIG. 1.

FIG. 7 is an explanatory drawing showing an example of display information displayed on a display apparatus shown in FIG. 1.

FIG. 8 is a structural view showing a radiation measurement apparatus according to embodiment 2, which is another embodiment of the present invention.

FIG. 9 is a structural view showing a radiation measurement apparatus according to embodiment 3, which is another embodiment of the present invention.

FIG. 10 is a structural view showing a radiation measurement apparatus according to embodiment 4, which is another embodiment of the present invention.

FIG. 11 is an explanatory drawing showing an example of a method of integrating pulse signal after digital conversion in a digital signal integration circuit of a radiation measurement apparatus according to embodiment 5, which is another embodiment of the present invention.

FIG. 12 is an explanatory drawing showing an example of a method of removing pile-up at the time of integration of the pulse signal after digital conversion in a digital signal integration circuit of embodiment 5.

FIG. 13 is an explanatory drawing showing an example of processing of pulse signal after digital conversion in a threshold circuit and digital signal integration circuit of a radiation measurement apparatus according to embodiment 6, which is another embodiment of the present invention.

FIG. 14 an explanatory drawing showing an example of processing of pulse signal after digital conversion in a threshold circuit and digital signal integration circuit of a radiation measurement apparatus according to embodiment 7, which is another embodiment of the present invention.

FIG. 15 is an explanatory drawing showing an example of processing of pulse signal after digital conversion in a preamplifier of a radiation measurement apparatus according to embodiment 8, which is another embodiment of the present invention.

### DETAILED DESCRIPTION OF THE PREFERRED EMBODIMENTS

The embodiments of the present invention will be explained below.

### Embodiment 1

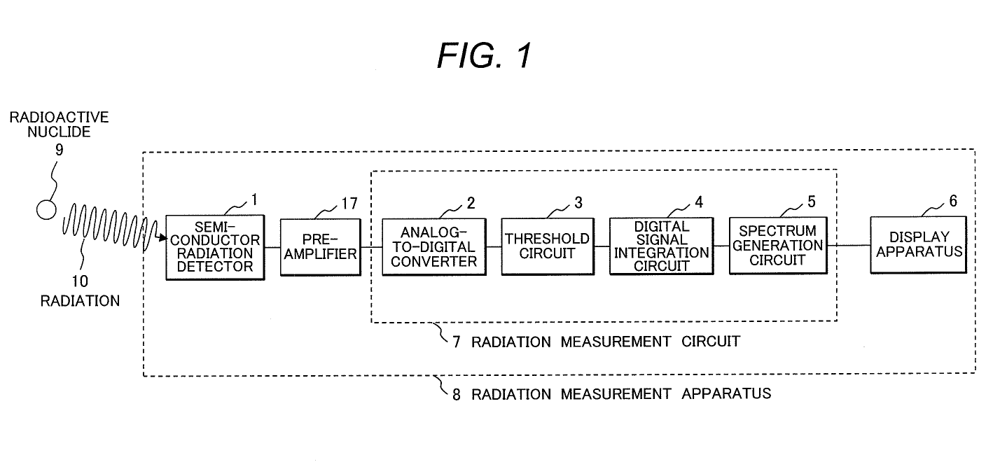

A radiation measurement apparatus according to embodiment 1, which is a preferred embodiment of the present invention, will be explained by referring to FIG. 1. A radiation measurement apparatus 8 of the present embodiment includes a semiconductor radiation detector 1, a preamplifier 17, a radiation measurement circuit 7, and a display apparatus 6. The radiation measurement circuit 7 has an analog-to-digital converter (analog-to-digital conversion apparatus) 2, a threshold circuit (threshold apparatus) 3, a digital signal integration circuit (digital signal integration apparatus) 4, and a spectrum generation circuit (spectrum generation apparatus) 5. The semiconductor radiation detector 1 uses a silicon radiation detector, a germanium radiation detector, a CdTe radiation detector, GaAs radiation detector, TlBr radiation detector, a HgI₂ radiation detector, or a CZT radiation detector.

The semiconductor radiation detector 1 is connected to the preamplifier 17 and the preamplifier 17 is connected to the analog-to-digital converter 2. The analog-to-digital converter 2 is connected to the threshold circuit 3 and the threshold circuit 3 is connected to the digital signal integration circuit 4. The digital signal integration circuit 4 is connected to the spectrum generation circuit 5 and the spectrum generation circuit 5 is connected to the display apparatus 6.

The semiconductor radiation detector 1 detects radiation 10 emitted from a radioactive nuclide 9. In the present embodiment, the semiconductor radiation detector 1 detects the radiation 10 emitted from the radioactive nuclide 9, though it can detect radiation generated by an accelerator and cosmic rays. Further, the radiation that can be detected by the semiconductor radiation detector 1 is α rays, β rays, γ rays, X-rays, neutron, proton, a heavy ion beam, and cosmic rays.

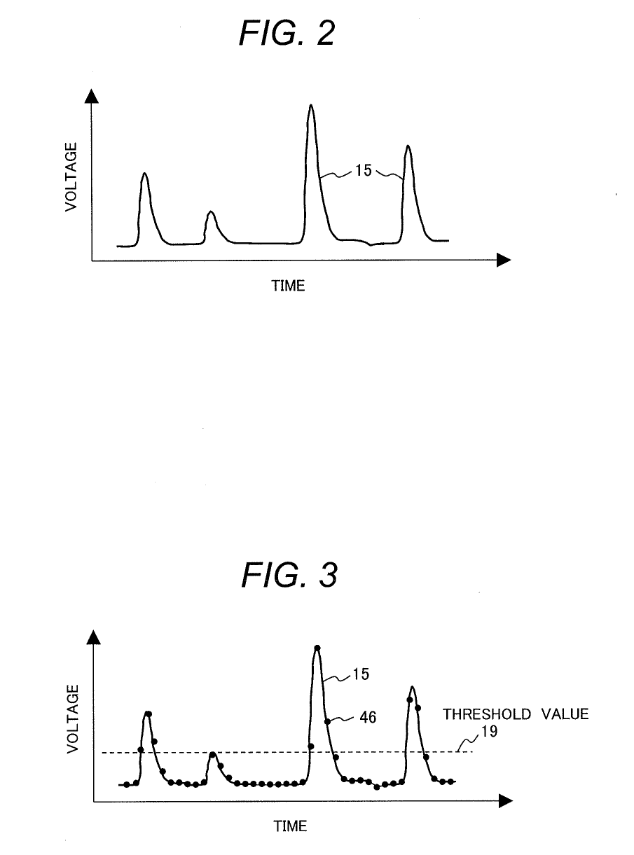

The semiconductor radiation detector 1 outputs a pulse signal 15 that is a radiation detection signal whenever it detects the radiation 10. This pulse signal 15 is an analog signal and an example of the pulse signal is shown in FIG. 2. Each peak shown in FIG. 2 is the pulse signal (radiation detection signal) 15. A longitudinal axis shown in FIG. 2 indicates a voltage and a horizontal axis indicates time. The peak value of each pulse signal 15 correlates with the respective radiation energy detected by the semiconductor radiation detector 1.

Each pulse signal 15 output from the semiconductor radiation detector 1 is amplified by the preamplifier 17 and then is input to the analog-to-digital converter 2. The analog-to-digital converter 2 converts the pulse signal 15 that is an input analog signal to a digital signal. By the way, the pulse signal 15 that is an analog signal is referred to as an analog pulse signal. The pulse signal after analog-to-digital conversion that is output from the analog-to-digital converter 2 is indicated by black circles in FIG. 3. The black circles are referred to as a digital pulse signal, which is described by “a digital pulse signal 46”. The solid line shown in FIG. 3 indicates an analog pulse signal.

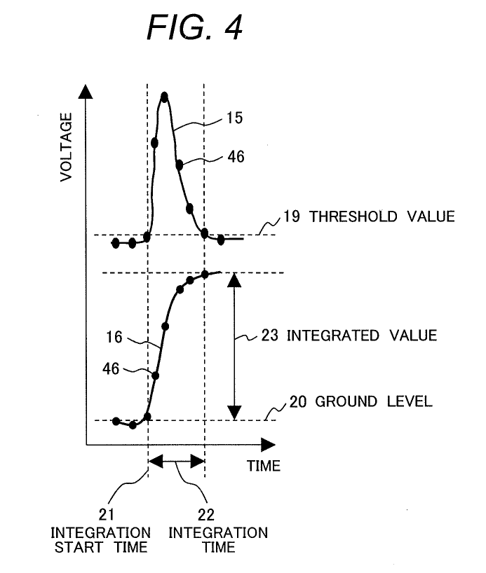

The analog-to-digital converter 2 converts each of the analog pulse signals 15 that are input in continuous quantity to a digital signal (digital pulse signal) 46 that is a discrete value (refer to an upper stage of FIG. 4). For the analog-to-digital converter 2, an analog-to-digital converter of a flash type, a pipeline type, a successive approximation type, a delta sigma type, or a double integral type can be used. When using the radiation measurement apparatus 8 in an environment of a high counting rate (a range of a counting rate of 10⁴ cps or higher) and a high dose rate (an environment of a counting rate of 10⁴ cps or higher), the analog pulse signal 15 output from the semiconductor radiation detector 1 speeds up, so that the analog-to-digital converter 2 must use an analog-to-digital converter having a high-speed sampling cycle function. Concretely, if the analog pulse signal 15 output from the semiconductor radiation detector 1 speeds up, the number of output analog pulse signals increases, and the output interval of analog pulse signals from the semiconductor radiation detector 1 is shortened, so that the analog-to-digital converter 2 uses an analog-to-digital converter of a short sampling cycle. For example, when the semiconductor radiation detector 1 uses the germanium radiation detector, generally, the quantitative analysis and energy analysis of the radioactive nuclide 9 is executed at a resolution of 12 bits or more.

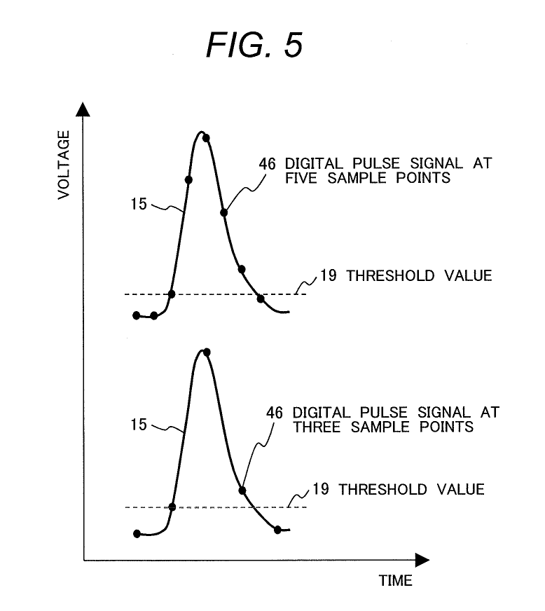

The analog-to-digital converter 2 outputs the digital pulse signal 46 at five sample points (refer to an upper stage of FIG. 5) for one analog pulse signal 15. A lower stage of FIG. 5 indicates the digital pulse signals 46 at three sample points of one analog pulse signal 15. Each solid line at the upper stage and lower stage of FIG. 5 indicates the analog pulse signal 15. By the analog-to-digital conversion of the analog-to-digital converter 2, the data of the continuous analog pulse signal 15 is handled as a discrete value (the voltage of each digital pulse signal 46), so that an error is caused to a computed value (for example, an integrated value 23 shown in FIG. 4) of the radiation energy that will be described later due to the number of sample points of one analog pulse signal 15. In order to reduce the error of the discrete data (each digital pulse signal 46) for the standardized continuous data (the analog-digital signal 15) to 0.1% or lower, it is necessary to set the number of sample points for generating the digital pulse signals 46 to five points or more. By doing this, for the radiation energy of a certain analog pulse signal 15, the error of the radiation energy obtained by integration of the digital pulse signals 46 at the five or more sample points for the analog signal 15 can be reduced to 0.1% or lower.

The voltage value at each sample point of the analog pulse signal 15 output from the semiconductor radiation detector correlates with the energy of the radiation 10 detected by the semiconductor radiation detector 1, so that if the energy of the radiation 10 entering the semiconductor radiation detector 1 is known, the number of sample points for one analog pulse signal 15 can be controlled easily. Since the cycle of sample points is decided by the digital processing circuit (the threshold circuit 3, digital signal integration circuit 4, and spectrum generation circuit 5), if the processing time for one analog pulse signal is fixed, the number of sample points can be controlled. The control for the number of sample points is performed by the analog-to-digital converter 2, for example, based on the decided cycle of sample points. The number of sample points for one analog pulse signal 15 is set to five or more, thus the quantitative analysis and energy analysis of the radioactive nuclide 9 can be performed accurately. The number of sample points in the present embodiment is five (refer to the upper stage of FIG. 4).

As a typical system of the threshold circuit, a leading edge timing system and a constant fraction timing system may be cited. The threshold circuit 3 used in the present embodiment is a threshold circuit with the leading edge timing system applied. The threshold circuit 3 sets a threshold value 19 (refer to FIGS. 3 and 4). The threshold circuit 3 inputting the digital pulse signals 46 output from the analog-to-digital converter 2 discriminates digital pulse signals 46 having a voltage exceeding the threshold value 19 (refer to the upper stage of FIG. 4) and outputs them to the digital signal integration circuit 4.

The threshold circuit with the leading edge timing system applied is a most simple discrimination system for discriminating from whether the peak value of the radiation detection signal output from the radiation detector exceeds the threshold value or not and is generally used in measurement apparatuses in many fields other than the radiation measurement. Further, the threshold circuit with the constant fraction timing system applied is used when the rise time of pulse height of the radiation detection signal output from the radiation detector is different. By the threshold circuit with the constant fraction timing system applied, the peak of the radiation detection signal independent of the radiation energy entered to the semiconductor radiation detector 1 can be discriminated.

The operation of the digital signal integration circuit 4 for integrating the digital pulse signals 46 that is a digital signal integration apparatus will be explained below. The digital signal integration circuit 4 inputs each digital pulse signal 46 (refer to the upper stage of FIG. 4) output from the threshold circuit 3, integrates the voltage of each digital pulse signal 46, and calculates the integrated value 23 (refer to the lower stage of FIG. 4). The integrated value 23 is calculated as indicated below.

In FIG. 4, integration start time 21 is the time when the digital pulse signal 46 for the one analog pulse signal 15 exceeds the threshold value 19, and integration time 22 is the time from this time until the digital pulse signal 46 is lowered to the threshold value 19 after the largest digital pulse signal for the one analog pulse signal 15. A first time (the integration start time 21) when the digital pulse signal 46 for the one analog pulse signal 15 exceeds the threshold value 19 and a second time when the digital pulse signal 46 is lowered to the threshold value 19 after the largest digital pulse signal for the one analog pulse signal 15 are input from the threshold circuit 3 to the digital signal integration circuit 4. The difference between the second time and the first time (almost equal to the time when the digital pulse signal for the one analog pulse signal 15 is equal to or more than the threshold value) is the integration time 22.

The digital signal integration circuit 4 integrates the respective voltages of the digital pulse signals 46 at five points that are input during the integration time 22 after the integration start time 21, for one analog pulse signal 15, thereby calculates the integrated value 23. A solid line 16 shown at the lower stage of FIG. 4, in the state that the respective voltages of the digital pulse signals 46 at the five sample points existing during the integration time 22 are integrated, is a line for connecting these digital pulse signals 46. The calculation of the integrated value 23 is performed by using each of the analog pulse signals 15 having a voltage higher than the threshold value 19 among the analog pulse signals 15 output from the semiconductor radiation detector 1. The integrated value 23 is a difference from a ground level 20. Further, the integrated value 23 calculated is equivalent to the energy of the radiation 10 entering the semiconductor radiation detector 1 for outputting one analog pulse signal 15 from the semiconductor radiation detector 1.

The digital signal integration circuit 4 generates the digital pulse signals 46 at five sample points of the analog pulse signal 15, integrates these digital pulse signals, thereby obtains the integrated value 23. Therefore, the digital signal integration circuit 4 approximately obtains an integral value of each of the analog pulse signals 15. In the analog-to-digital converter 2, if the number of sample points for converting each of the analog pulse signals 15 to the digital pulse signal 46 is set to six or larger, the aforementioned integral value becomes closer to the integral value of the analog pulse signals 15.

The integrated value 23 of the voltages of the digital pulse signals 46 at five points of each of the analog pulse signals 15 that is calculated by the digital signal integration circuit 4 is input to the spectrum generation circuit 5. The spectrum generation circuit 5 counts the integrated value 23 for each of the analog pulse signals 15 output from the semiconductor radiation detector 1 for each integrated value 23 assuming the integrated value 23 for one analog pulse signal 15 as one, during a predetermined measuring period of time for measuring the radiation 10 emitted from the radioactive nuclide 9. The count value of the integrated value 23 indicates the counting value of the analog pulse signals 15 output from the semiconductor radiation detector 1, that is, the counting value of the radiation 10 entering the semiconductor radiation detector 1. Counting of the integrated value 23 for each value of the integrated value 23 is equivalent to counting of the radiation 10 entering the semiconductor radiation detector 1, concretely, the analog pulse signals 15 output from the semiconductor radiation detector 1 for each energy of the incident radiation 10.

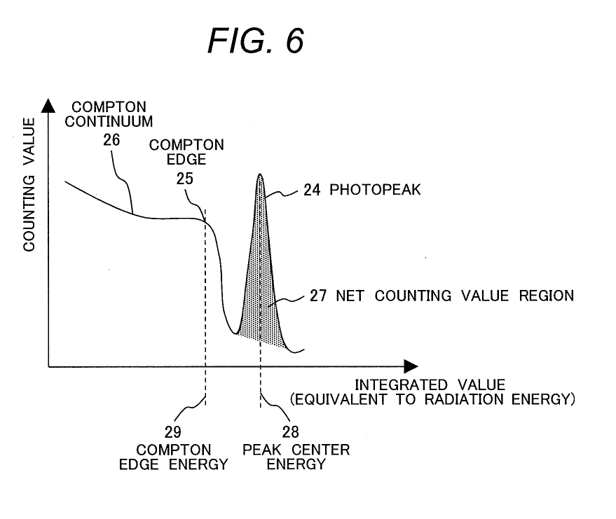

The spectrum generation circuit 5 prepares radiation energy spectrum information (refer to FIG. 6) based on the counting value of the integrated value 23 counted for each calculated integrated value 23 (the energy of the radiation 10 entering the semiconductor radiation detector 1) assuming the integrated value 23 for one analog pulse signal as one. An example of the radiation energy spectrum shown in FIG. 6 has a photopeak 24 and a Compton continuum 26. A longitudinal axis shown in FIG. 6 indicates the counting value and a horizontal axis indicates the integrated value (equivalent to the energy of the radiation 10 entering the semiconductor radiation detector 1) 23.

The quantitative analysis and energy analysis of the radioactive nuclide 9 executed by the spectrum generation circuit 5 using the radiation energy spectrum information will be explained below.

Firstly, the energy analysis will be explained. In the radiation energy spectrum, the photopeak 24 and a Compton edge 25 of the Compton continuum 26 correlate with the energy of the radiation 10 entering the semiconductor radiation detector 1. Therefore, peak center energy 28 of the photopeak 24 can be approximated to all the energy of the radiation 10 entering the semiconductor radiation detector 1 and all the energy of the radiation 10 can be evaluated based on Compton edge energy 29 of the Compton edge 25.

When there exist a plurality of photopeaks 24 and a plurality of Compton edges 25 in the radiation energy spectrum, if any of the photopeaks 24 or any of the Compton edges 25 are known, the peak center energy 28 and the Compton edge energy 29 can be calculated in the spectrum generation circuit 5 by fitting by a primary function or a secondary function that is generally executed.

Next, the quantitative analysis of the radioactive nuclide 9 executed by the spectrum generation circuit will be explained. Further, the kind of the radioactive nuclide 9 for emitting the radiation 10 entering the semiconductor radiation detector 1 is identified based on the peak center energy 28. Furthermore, a net counting value 27 for the identified radioactive nuclide 9 is calculated based on the photopeak 24 using a known general method. Furthermore, the identified radioactive nuclide 9 can be quantified by adding an emission rate of each energy radiation emitted by the radioactive nuclide 9, geometrical efficiency of the semiconductor radiation detector 1, detection efficiency of the radiation 10 of the semiconductor radiation detector 1, a radiation emission rate of the radioactive nuclide 9, and a correction efficiency of radiation shielding conditions of the semiconductor radiation detector 1 to the area of the calculated net counting value region 27.

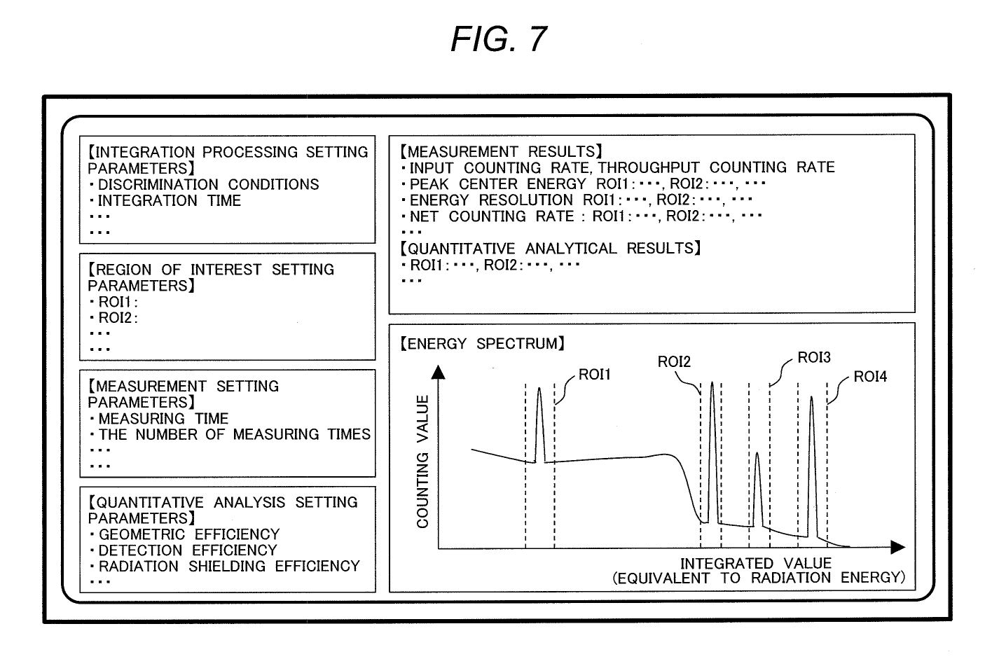

The spectrum generation circuit 5 outputs the obtained information of the results of the quantitative analysis and energy analysis of the radioactive nuclide 9 to the display apparatus 6. The display apparatus 6 shows the information. An example of the display information displayed on the display apparatus 6 is shown in FIG. 7. The display information includes integration processing setting parameters such as the discrimination conditions and integration time, ROI (region of interest) setting parameters for setting ROIs of the photopeak and others that can be obtained by the energy spectrum, measurement setting parameters for setting the measuring time and the number of measuring times, quantitative analysis setting parameters for setting the geometrical efficiency of the semiconductor radiation detector 1, the detection efficiency of the radiation 10, and the correction efficiency of the radiation shielding conditions of the semiconductor radiation detector 1, and measurement results, that is, the input counting rate, throughput counting rate, peak center energy of each ROI, energy resolution, net counting rate, quantitative analytical results, and radiation energy spectrum information.

According to the present embodiment, for each of the analog pulse signals 15, the digital pulse signals 46 at the respective sample points exceeding the threshold value 19 that are output from the threshold circuit 3 are integrated by the digital signal integration circuit 4, so that the radiation energy information (the integrated value 23) included in each of the analog pulse signals 15 output from the semiconductor radiation detector 1 can be obtained while the time resolution of the semiconductor radiation detector 1 is maintained. Furthermore, in the present embodiment, the radiation energy information (the integrated value 23) obtained by the digital signal integration circuit 4 is used in the spectrum generation circuit 5, thereby can prepare the radiation energy spectrum information during measurement of the radiation 10, that is, prepare it in real time, and can easily and accurately perform the quantitative analysis and energy analysis of the radioactive nuclide 9.

The radiation measurement apparatus 8 of the present embodiment for obtaining the aforementioned effect can measure the radiation 10 in a high counting rate environment, utilizing the performance such as the time resolution of the semiconductor radiation detector 1 at its maximum and can perform the quantitative analysis and energy analysis of the radioactive nuclide 9 accurately in a short period of time. Therefore, the radiation measurement apparatus 8 of the present embodiment can shorten the measuring time of the radiation 10. In addition, the thickness of the radiation shielding body of the semiconductor radiation detector 1 can be decreased because the radiation measurement apparatus 8 can perform measurement of the radiation 10 in the high counting rate environment. Thus, compactness and reduction in weight of the semiconductor radiation detector 1 including the radiation shielding body can be realized.

In the present embodiment, the analog-to-digital converter 2 is arranged at a former stage of the digital signal integration circuit 4, and the digital signal integration circuit 4 inputs the digital pulse signals 46 generated by the analog-to-digital converter 2, so that the signal processing in the digital signal integration circuit 4 and each circuit at the later stage thereof can be digitally performed, and a connection with another device, for example, with the display apparatus, that is, a transfer of information is made easily. Further, the analog-to-digital converter 2 is arranged at a former stage of the digital signal integration circuit 4, thus the analog pulse signals can be digitized at an early stage, and the anti-noise performance to electric noise such as induced noise is improved.

In the present embodiment, the number of sample points for generating the digital pulse signals 46 is set to five in one analog pulse signal 15, so that for the continuous analog pulse signals 15, the error of the radiation energy (the integrated value 23) of the analog pulse signal 15 obtained by using the voltage of each of the digital pulse signals 46 that is a discrete value can be suppressed to 0.1% or lower.

Since the present embodiment has the threshold circuit 3, electric noise and a signal caused by a radioactive nuclide other than the measurement subject can be removed by the threshold circuit 3. Therefore, the digital signal integration circuit 4 for inputting the digital pulse signals 46 output from the threshold circuit 3 can accurately obtain the radiation energy (the integrated value 23) of the radiation 10 emitted from the radioactive nuclide 9 of the measurement subject. Further, the digital pulse signals 46 exceeding the threshold value 19 are output from the threshold circuit 3, so that unnecessary information inputting to the digital signal integration circuit 4 and the spectrum generation circuit 5 is reduced. Therefore, the load to the digital signal integration circuit 4 and the spectrum generation circuit 5 is reduced.

In the present embodiment, the integration processing of each of the digital pulse signals 46 for the analog pulse signal 15 in the digital signal integration circuit 4 can be synchronized with the pulse height discrimination process of the digital pulse signals 46 in the threshold circuit 3 because the first time when the digital pulse signals 46 for one analog pulse signal 15 exceed the threshold value 19 is assumed as the integration start time 21 of the digital pulse signals 46 in the digital signal integration circuit 4. Therefore, according to the present embodiment, a more accurate quantitative analysis and energy analysis of the radioactive nuclide 9 can be performed.

According to the present embodiment, the analog pulse signals 15 that are output of the semiconductor radiation detector 1 are input to the preamplifier 17, so that the signal-to-noise ratio (SN ratio) of the analog pulse signals 15 can be improved and quantitative analysis and energy analysis of a higher resolution of a radioactive nuclide can be performed.

In the spectrum generation circuit 5 of the radiation measurement apparatus 8 of the present embodiment, the radiation energy spectrum information in which the horizontal axis is the integrated value 23 of a plurality of digital pulse signals 46 for one analog pulse signal 15 and the longitudinal axis is a counting value is prepared, so that radiation energy spectrum information equivalent to a peak value spectrum (the horizontal axis indicates a peak value of the radiation detection signal) used as a general radiation energy spectrum can be generated.

In the present embodiment, the quantitative analysis and energy analysis of the radioactive nuclide 9 that are executed by the spectrum generation circuit 5 are performed using the peak center energy 28 of the photopeak 24 or the Compton edge energy 29 of the Compton edge 25 obtained based on the radiation energy spectrum information, so that the quantitative analysis and energy analysis of the radioactive nuclide 9 based on the interaction of the radiation 10 and the semiconductor radiation detector 1 can be performed.

### Embodiment 2

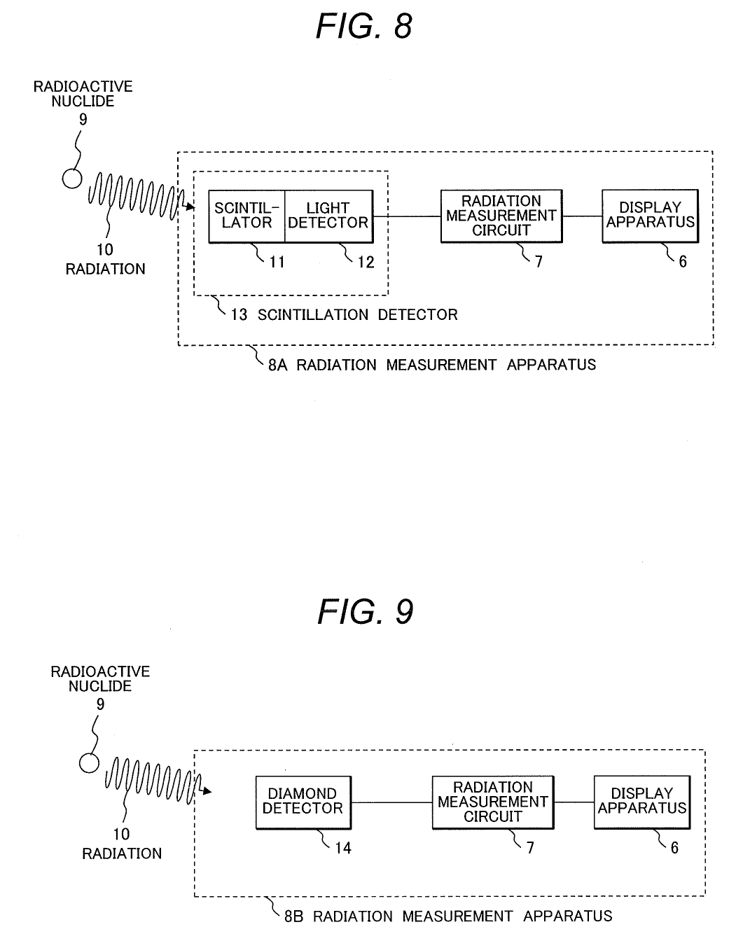

A radiation measurement apparatus according to embodiment 2, which is another embodiment of the present invention, will be explained below by referring to FIG. 8. A radiation measurement apparatus 8A of the present embodiment has a structure that in the radiation measurement apparatus 8 of the embodiment 1, the semiconductor radiation detector 1 is replaced with a scintillation detector (radiation detector) 13 and the preamplifier 17 is removed. The other structure of the radiation measurement apparatus 8A is the same as that of the radiation measurement apparatus 8 of the embodiment 1.

The radiation measurement apparatus 8A is provided with a scintillation detector 13, the radiation measurement circuit 7, and the display apparatus 6. The scintillation detector 13 has a scintillator 11 and a light detector 12. The scintillator 11 for detecting the radiation 10 is optically connected to the light detector 12 and the light detector 12 is connected to the analog-to-digital converter 2 of the radiation measurement circuit 7.

As a scintillator 11 for detecting radiation and emitting scintillation, a scintillator made of NaI (Tl), BGO, GSO, LSO, YAP, LuAG (Pr), LaBr₃ (Ce), CsI, or PWO is used. Particularly, when it is used in an environment of a high counting rate and a high dose rate, a scintillator with a short scintillation decay time is necessary. As a scintillator having a scintillation decay time of 100 ns or shorter, there is a scintillator made of LaBr₃ (Ce), LaCl₃ (Ce), LSO (Ce), YAG, GSO (Ce), PWO, CeF₂, LuAG (Pr), or LuAg (Ce) available.

The light detector 12 inputs the scintillation generated in the scintillator 11 and converts the scintillation to an electric signal. For the light detector 12, a photomultiplier, a photodiode or an avalanche photodiode are used.

In the present embodiment requiring a high speed of the signal processing, as a light detector 12, the photomultiplier is used and the voltage of the analog pulse signal 15 output from the photomultiplier is high, so that the preamplifier 17 used in the embodiment 1 is not necessary. Even when using the photomultiplier as a light detector 12, when aiming at improvement of the SN ratio at the slight sacrifice of the high speed of the signal processing, the photomultiplier may be connected to the analog-to-digital converter 2 via the preamplifier 17. Further, in the radiation measurement apparatus 8A using the photodiode as a light detector 12, it is necessary to connect the preamplifier 17 to the output end of the photodiode and connect the preamplifier 17 to the analog-to-digital converter 2 because the voltage of the analog pulse signal 15 output from the photodiode is low.

When the radiation 10 emitted from the radioactive nuclide 9 enters the scintillator 11, the scintillator 11 emits scintillation. The scintillation enters the light detector 12, and the light detector 12 converts the scintillation to an analog pulse signal 15 that is an electric signal, and outputs the analog pulse signal 15. The output analog pulse signal 15 is input to the analog-to-digital converter 2 of the radiation measurement circuit 7. The analog-to-digital converter 2, the threshold circuit 3, the digital signal integration circuit 4, and the spectrum generation circuit 5 in the radiation measurement apparatus 8A of the present embodiment respectively execute the processing executed respectively by the analog-to-digital converter 2, the threshold circuit 3, the digital signal integration circuit 4, and the spectrum generation circuit 5 in the radiation measurement apparatus 8 of the embodiment 1.

As a result, the present embodiment integrates the voltage of each of the respective digital pulse signals 46 output from the threshold circuit 3 in the digital signal integration circuit 4, similarly to the embodiment 1, and thereby calculates the integrated value 23. The spectrum generation circuit 5 prepares radiation energy spectrum information using these integrated values 23 and executes the quantitative analysis and energy analysis of the radioactive nuclide 9.

The present embodiment can obtain each effect generated in the embodiment 1.

When using the radiation measurement apparatus 8A in an environment of a high counting rate (within the range of a counting rate of 10⁴ cps or higher) and a high dose rate, the analog pulse signal 15 output from the light detector 12 speeds up, so that the analog-to-digital converter 2 must use an analog-to-digital converter having a high-speed sampling cycle function. For example, when using a scintillator 11 having a scintillation decay time of 100 ns or shorter, the analog-to-digital converter 2 may use an analog-to-digital converter having a sampling cycle of 50 MHz or larger. The cycle of outputting the analog pulse signal 15 from the light detector 12 to the analog-to-digital converter 2 can be controlled to 20 ns by using an analog-to-digital converter 2 having a sampling cycle of 50 MHz or larger, so that even when using a scintillator 11 having a scintillation decay time of 100 ns or shorter for the scintillation detector 13, even if it inputs a high-speed analog pulse signal 15 having a pulse duration of 100 ns or shorter output from the light detector 12, the analog-to-digital converter 2 can convert it to a digital pulse signal 46. Therefore, even when the scintillator 11 having a scintillation decay time of 100 ns or shorter is used, the quantitative analysis and energy analysis of the radioactive nuclide 9 can be executed at a resolution of 10 bits or more. When using the scintillator 11 having a scintillation decay time of 100 ns or shorter, it is desirable that the analog-to-digital converter 2 uses an analog-to-digital converter having a sampling cycle within a range from 50 MHz to 2 GHz, which is a range capable of realizing the sampling cycle.

When the scintillator 11 having a scintillation decay time of 100 ns or shorter is used for the scintillation detector 13, even the radiation measurement apparatus 8A where the scintillation detector 13 is arranged in a region in a high counting rate environment of 10⁵ cps or higher or a high dose rate environment of several mSv/h or higher can execute an accurate quantitative analysis and energy analysis of the radioactive nuclide 9.

### Embodiment 3

A radiation measurement apparatus according to embodiment 3, which is another embodiment of the present invention, will be explained by referring to FIG. 9. The radiation measurement apparatus 8B of the present embodiment has a structure that in the radiation measurement apparatus 8 of the embodiment 1, the semiconductor radiation detector 1 is replaced with a diamond detector 14. The other structure of the radiation measurement apparatus 8B is the same as that of the radiation measurement apparatus 8 of the embodiment 1.

The diamond detector 14 uses diamond for the detection element in contrast to the semiconductor radiation detector 1 using a semiconductor for a detection element. However, similarly to the semiconductor radiation detector 1, the diamond detector 14 has a function of applying a voltage to the detection element, collecting electrons generated in the detection element due to the interaction with the incident radiation 10 in one electrode installed in the detection element, collecting holes generated in the detection element due to the interaction in another electrode installed in the detection element, and outputting a potential caused between the electrodes as an analog pulse signal 15.

The present embodiment can obtain each effect generated in the embodiment 1.

### Embodiment 4

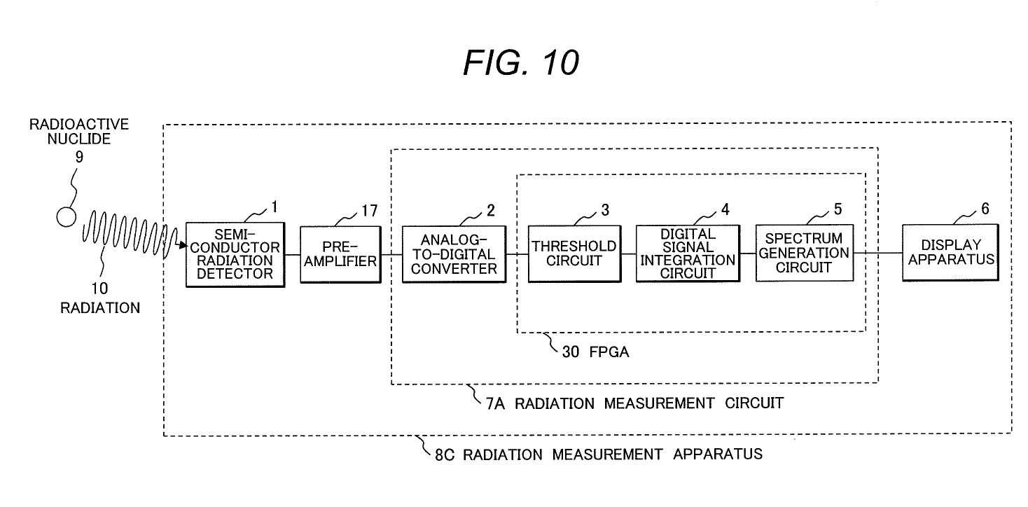

A radiation measurement apparatus according to embodiment 4, which is another embodiment of the present invention, will be explained by referring to FIG. 10. A radiation measurement apparatus 8C of the present embodiment has a structure that in the radiation measurement apparatus 8 of the embodiment 1, the radiation measurement circuit 7 is replaced with a radiation measurement circuit 7A. The other structure of the radiation measurement apparatus 8C is the same as that of the radiation measurement apparatus 8 of the embodiment 1.

The radiation measurement circuit 7A has the analog-digital circuit 2 and a rewritable field programmable gate array 30. The rewritable field programmable gate array is hereinafter referred to as FPGA. The FPGA 30 has the respective functions of the threshold circuit 3, the digital signal integration circuit 4, and the spectrum generation circuit 5 that are used in the radiation measurement circuit 7, and achieves the respective functions of the threshold circuit 3, the digital signal integration circuit 4, and the spectrum generation circuit 5 by a program. In the present embodiment, the respective functions of the threshold circuit 3, the digital signal integration circuit 4, and the spectrum generation circuit 5 that are achieved by the program are, for convenience, referred to as the threshold circuit 3, the digital signal integration circuit 4, and the spectrum generation circuit 5.

It is necessary to change the respective setting parameters of the threshold circuit 3, the digital signal integration circuit 4, and the spectrum generation circuit 5 according to the kind of radiation 10 measured by the semiconductor radiation detector 1. However, the radiation measurement apparatus 8C uses the FPGA 30, so that when changing the kind of the radiation 10 measured by the semiconductor radiation detector 1, for example, when changing the measurement of γ rays to α rays, the respective γ rays setting parameters of the threshold circuit 3, the digital signal integration circuit 4, and the spectrum generation circuit 5 are changed to the α rays setting parameters, thus the α rays can be measured by the radiation measurement apparatus 8C.

In the radiation measurement apparatus 8C, the analog pulse signal 15 output from the semiconductor radiation detector 1 is input to the analog-to-digital converter 2 via the preamplifier 17 and is converted to the digital pulse signal 46. The digital pulse signal 46 is input to the FPGA 30. In the FPGA 30, similarly to the embodiment 1, the respective processing of the threshold circuit 3, the digital signal integration circuit 4, and the spectrum generation circuit 5 are executed successively. For example, the respective display information shown in FIG. 7 is displayed on the display apparatus 6.

The present embodiment can obtain each effect generated in the embodiment 1. Furthermore, since the present embodiment has the FPGA 30, the setting parameters can be changed according to the kind of the radiation 10 measured by the semiconductor radiation detector 1. Therefore, the radiation measurement apparatus 8C can easily perform the quantitative analysis and energy analysis of a radioactive nuclide for emitting different radiation 10.

In the radiation measurement apparatus 8A of the embodiment 2 and the radiation measurement apparatus 8B of the embodiment 3, the threshold circuit 3, the digital signal integration circuit 4, and the spectrum generation circuit 5 of the radiation measurement circuit 7 may be replaced with the FPGA 30. In this case, in the respective FPGAs 30, the setting parameters for the scintillation detector 13 or the diamond detector 14 can be easily set.

### Embodiment 5

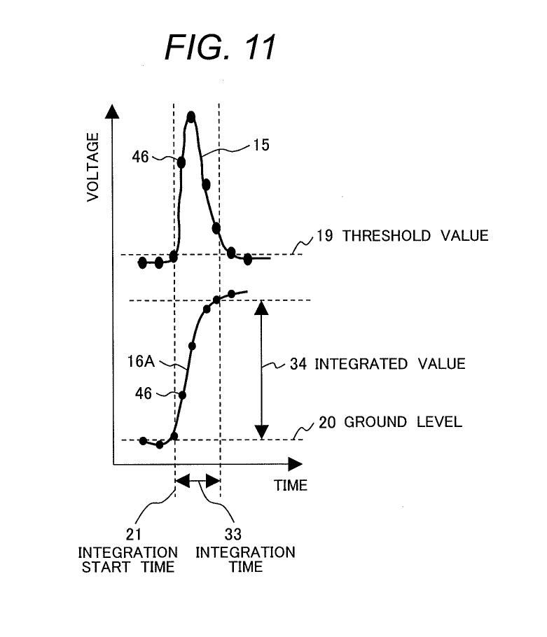

A radiation measurement apparatus according to embodiment 5, which is another embodiment of the present invention, will be explained by referring to FIGS. 1 and 11. The radiation measurement apparatus of the present embodiment has practically the same structure as that of the radiation measurement apparatus 8 of the embodiment 1. The radiation measurement apparatus of the present embodiment is different from the radiation measurement apparatus 8 only in the processing of the digital signal integration circuit 4.

In the radiation measurement apparatus of the present embodiment, the analog pulse signal 15 output from the semiconductor radiation detector 1 is amplified by the preamplifier 17, then is input to the analog-to-digital converter 2, and is converted to the digital pulse signals 46. The digital pulse signals 46 are input to the threshold circuit 3. The threshold circuit 3 outputs the digital pulse signals 46 exceeding the threshold value 19.

The digital signal integration circuit 4 used in the present embodiment is different from the digital signal integration circuit 4 used in the embodiment 1 and the integration time is preset in integration time 33. The digital signal integration circuit 4 used in the present embodiment assumes the first time when the digital pulse signals 46 for the analog pulse signal 15 exceed the threshold value 19 in the threshold circuit 3 as the integration start time 21 (refer to the upper stage of FIG. 11) and integrates the digital pulse signals 46 for one analog pulse signal 15 during the period from the starting point of the integration start time 21 to the lapse of the integration time 33. By this integration, an integrated value 34 of the digital pulse signals 46 for one analog pulse signal 15 is calculated by the digital signal integration circuit 4 (refer to the lower stage of FIG. 11). A solid line 16A shown at the lower stage of FIG. 11 is a line for connecting these digital pulse signals 46 in the state that the respective voltages of the digital pulse signals 46 at the five sample points existing during the integration time 33 are integrated.

The spectrum generation circuit 5 inputs the integrated value 34, prepares radiation energy spectrum information as with the spectrum generation circuit 5 of the embodiment 1 that inputs the integrated value 23, and executes the quantitative analysis and energy analysis of the radioactive nuclide 9 for emitting the radiation 10.

The integration time 33 that is set in the digital signal integration circuit 4 used in the present embodiment is always fixed, so that it can prevent pile-up of the analog-digital signal 15 in contrast to the integration time 22 used in the digital signal integration circuit 4 used in the embodiment 1.

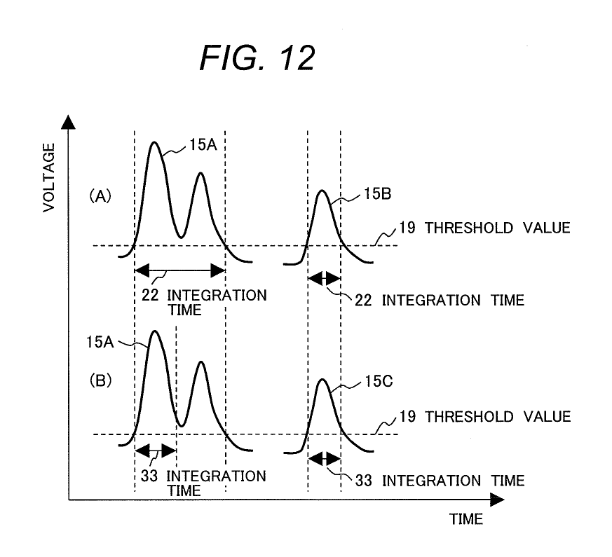

The pile-up will be explained below. When a plurality of, for example, two each of the radiation 10 enter the semiconductor radiation detector 1 for a short period of time, as shown in FIG. 12, an analog pulse signal 15A having two peaks where two analog pulse signals are overlaid with each other is output from the semiconductor radiation detector 1. In FIG. 12, the analog pulse signal 15A shows an example of a piled-up signal and analog pulse signals 15B and 15C show an example of non-piled-up signals. As shown in (A) at an upper stage of FIG. 12, in the embodiment 1, the period of time from the first time (the integration start time 21) when the analog pulse signal 15A exceeds the threshold value 19 to the second time when the analog pulse signal 15A reduces to the threshold value 19 is the integration time 22 during which the digital signal integration circuit 4 executes the integration processing. When a plurality of, for example, two analog pulse signals are overlaid with each other and are piled up, the integration time 22 becomes longer than the integration time 21 for one analog pulse signal having one peak that is shown in FIG. 4.

In the present embodiment the integration time 33 from the starting point of the integration start time 21 is preset in the digital signal integration circuit 4, as shown in (B) at a lower stage of FIG. 12. Therefore, the integrated value 34 of a plurality of digital pulse signals 46 for the analog pulse signal 15A, that are integration-processed by the digital signal integration circuit 4 does not include a plurality of digital pulse signals 46 for a portion for forming a second peak connected to a tail portion of a first peak of the analog pulse signal 15A. As mentioned above, even if piling-up is caused, the present embodiment can accurately execute the quantitative analysis and energy analysis of the radioactive nuclide 9. Particularly, even if the semiconductor radiation detector 1 is disposed in a region in a high counting rate environment where piling-up is easily caused, an accurate quantitative analysis and energy analysis of the radioactive nuclide 9 can be executed.

Furthermore, the present embodiment can obtain each effect generated in the embodiment 1.

In any of the embodiments 2 to 4, similarly to the present embodiment, the integration time 33 may be preset.

### Embodiment 6

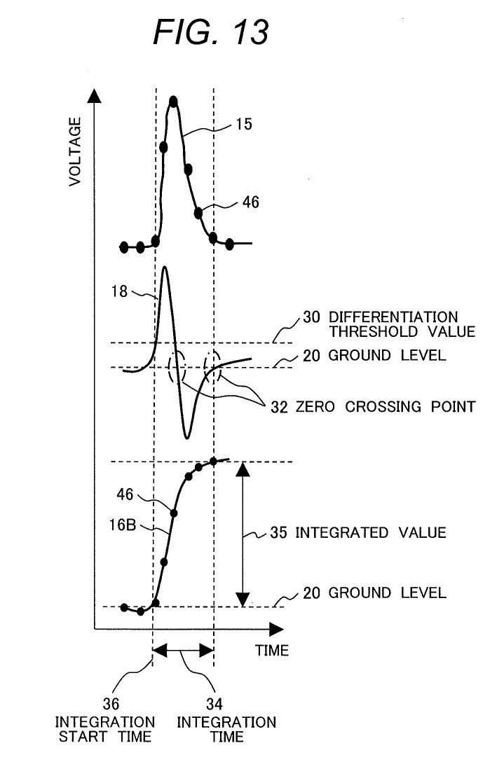

A radiation measurement apparatus according to embodiment 6, which is another embodiment of the present invention, will be explained by referring to FIGS. 1 and 13. The radiation measurement apparatus of the present embodiment has substantially the same structure as that of the radiation measurement apparatus 8 of the embodiment 1. The radiation measurement apparatus of the present embodiment is different from the radiation measurement apparatus 8 of the embodiment 1 only in each processing of the threshold circuit 3 and the digital signal integration circuit 4.

In the radiation measurement apparatus of the present embodiment, the analog pulse signal 15 output from the semiconductor radiation detector 1 is amplified by the preamplifier 17, then is input to the analog-to-digital converter 2, and is converted to the digital pulse signals 46. The digital pulse signals 46 are input to the threshold circuit 3.

Firstly, the processing of the threshold circuit 3 in the radiation measurement apparatus of the present embodiment will be explained. The digital pulse signals 46 at five sample points are input to the threshold circuit 3, for every analog pulse signal 15 shown at an upper stage of FIG. 13. The threshold circuit 3 obtains an approximate differentiation waveform 18 (refer to a middle stage of FIG. 13) of the corresponding analog pulse signal 15 using the digital pulse signals 46 and discriminates the digital pulse signals 46 existing during the period of time (equivalent to the integration time 34 described later) between a third time (integration start time 36) when the differentiation waveform 18 exceeds a differentiation threshold value 30 and a fourth time at a second zero crossing point 32 of the differentiation waveform 18 crossing the ground level 20. And, the threshold circuit 3 outputs the plurality of digital pulse signals 46, which exist between the third time and the fourth time in the corresponding analog pulse signal 15 and are discriminated, to the digital signal integration circuit 4. With respect to the approximate differential waveform of the analog pulse signal 15, for example, it is desirable to obtain the different value of the digital pulse signals 46 at two adjacent points as a differential value using the corresponding digital pulse signals 46.

The digital signal integration circuit 4 assumes the difference between the fourth time and the third time as the integration time 34, integrates the plurality of digital pulse signals 46 input from the threshold circuit 3 that exist during the integration time 34, and calculates an integrated value 35 (refer to a lower stage of FIG. 13). The integrated value 35 is a value on the basis of the ground level 20. A solid line 16B shown at the lower stage of FIG. 13 is a line for connecting these digital pulse signals 46 in a state that the respective voltages of the digital pulse signals 46 at the five sample points existing during the integration time 34 are added.

The spectrum generation circuit 5 inputs the integrated value 35, prepares radiation energy spectrum information as in the case of the spectrum generation circuit 5 of the embodiment 1 that inputs the integrated value 23, and executes the quantitative analysis and energy analysis of the radioactive nuclide 9 for emitting the radiation 10.

The present embodiment can obtain each effect generated in the embodiment 1.

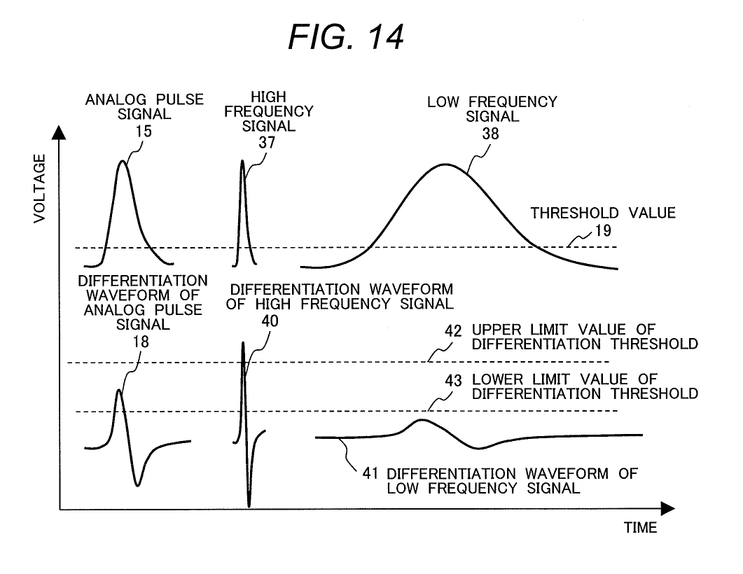

The present embodiment obtains the differentiation waveform 18 using the plurality of digital pulse signals 46 input from the threshold circuit 3 for each of the analog pulse signals 15, so that it can obtain the following effect. Each of the analog pulse signals 15 output from the semiconductor radiation detector 1 includes a high frequency signal 37 and a low frequency signal 38 that are electric noise, as shown at an upper stage of FIG. 14. The high frequency signal 37 and the low frequency signal 38 are analog signals. As mentioned above, when obtaining the differentiation waveform 18 for the analog pulse signals 15 by the threshold circuit 3, a differentiation waveform 40 for the high frequency signal 37 and a differentiation waveform 41 for the low frequency signal 38 can be obtained. The differentiation waveform 40 and the differentiation waveform 41 are separated by the threshold circuit 3 using a differentiation threshold upper limit value 42 and a differentiation threshold lower limit value 43.

The differentiation threshold upper limit value 42 and the differentiation threshold lower limit value 43 (refer to a lower stage of FIG. 14) are preset in the threshold circuit 3 before the radiation 10 is measured. The threshold circuit 3 outputs the differentiation waveform 18 existing between the differentiation threshold upper limit value 42 and the differentiation threshold lower limit value 43 among the differentiation waveforms 18 for the analog pulse signals 15 to the digital signal integration circuit 4. In the high frequency signal 37 having a short rise time and a short fall time compared with the analog pulse signal 15, even if the peak value level is equivalent to that of the analog pulse signal 15, the level of the differentiation waveform 40 becomes higher than the level of the differentiation waveform 18. Further, in the low frequency signal 38 having a long rise time and a long fall time compared with the analog pulse signal 15, even if the peak value level is equivalent to that of the analog pulse signal 15, the level of the differentiation waveform 41 becomes lower than the level of the differentiation waveform 18. Therefore, the high frequency signal 37 and the low frequency signal 38 that cannot be discriminated from the analog pulse signal 15 by the threshold value 19 can be discriminated from the analog pulse signal 15 based on each duration of the rise time and fall time. Accordingly, the present embodiment capable of removing the high frequency signal 37 and the low frequency signal 38 has excellent anti-noise performance and can execute an accurate quantitative analysis and energy analysis of the radioactive nuclide 9.

In any of the embodiments 2 to 5, every processing of the threshold circuit 3 and the digital signal integration circuit 4 of the present embodiment may be applied.

### Embodiment 7

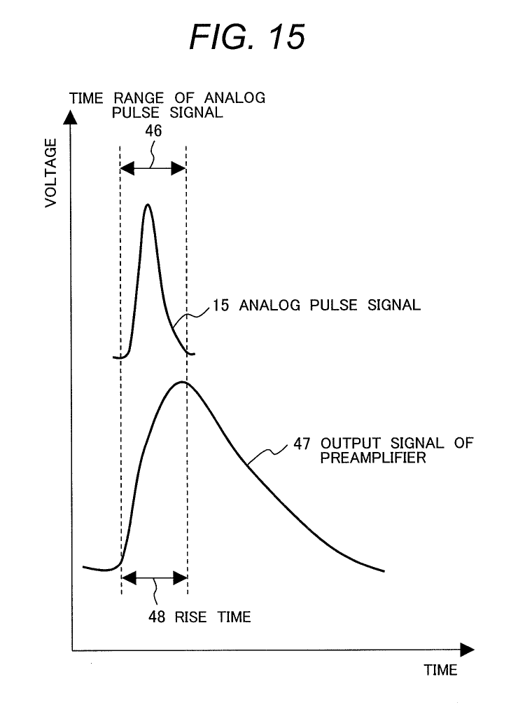

A radiation measurement apparatus according to embodiment 8, which is another embodiment of the present invention, will be explained by referring to FIGS. 1 and 15. The radiation measurement apparatus of the present embodiment has substantially the same structure as that of the radiation measurement apparatus 8 of the embodiment 1. The radiation measurement apparatus of the present embodiment is different from the radiation measurement apparatus 8 only in the processing of the preamplifier 17.

The analog pulse signal 15 output from the semiconductor radiation detector 1 (refer to FIG. 15) is input to the preamplifier 17. The analog pulse signal 15 has a time range 46 shown in FIG. 15. The preamplifier 17 shapes the input analog pulse signal 15 having the time range 46 to a preamplifier output signal 47 that is an analog pulse signal 15 having rise time 48. The rise time 48 of the preamplifier output signal 47 is the time range 46 or shorter. Similarly to the embodiment 1, the preamplifier output signal 47 that is an analog pulse signal is input to the analog-to-digital converter 2 and is converted to an analog pulse signal 15A at five sample points. The corresponding digital pulse signal 15A to each of the analog signals 15 is input to the threshold circuit 4, is discriminated as described in the embodiment 1, and is integrated by the digital signal integration circuit 4. The spectrum generation circuit 5 prepares radiation energy spectrum information using the integrated value output from the digital signal integration circuit 4 and executes the quantitative analysis and energy analysis of the radioactive nuclide 9.

The present embodiment can obtain each effect generated in the embodiment 1. The present embodiment sets the rise time 48 of the preamplifier output signal 47 to the time range 46 or shorter, so that it can maintain the time resolution of the semiconductor radiation detector 1, can improve the anti-noise performance of the preamplifier output signal 47 due to installation of the preamplifier 17, and can maintain the energy resolution. Therefore, the present embodiment can execute a more accurate quantitative analysis and energy analysis of the radioactive nuclide 9.

In any of the embodiment 4 to 6, every processing of the preamplifier 17 of the present embodiment may be applied.

Each radiation measurement apparatus of the embodiments 1 to 7 aforementioned can be applied to measurement of radiation in radioactive material handling facilities such as a nuclear power plant, medical facilities, an accelerator apparatus, and aerospace apparatus. In the nuclear power plant, the radiation measurement apparatus thereof is used as a radiation monitor in the reactor, primary containment vessel, primary coolant pipe, steam generator, and spent fuel pool. In the medical facilities, the radiation measurement apparatus thereof is applied to the radiation measurement apparatus system such as charged particle beam irradiation to a patient of charged particle beam (proton or heavy particle beam) treatment, a positron emission tomography method (PET), and a single photon emission computed tomography method (SPECT). In the accelerator apparatus, the radiation measurement apparatus thereof can be applied to a particle beam measuring system, neutron beam measuring system, and beam monitor. In the aerospace apparatus, the radiation measurement apparatus thereof is applied to the astronomical observation system.

### REFERENCE SIGNS LIST

1: semiconductor radiation detector, 2: analog-to-digital converter, 3: threshold circuit, 4: digital signal integration circuit, 5: spectrum generation circuit, 7, 7A: radiation measurement circuit, 8, 8A, 8B, 8C: radiation measurement apparatus, 9: radioactive nuclide, 10: radiation, 11: scintillator, 12: light detector, 13: scintillation detector, 14: diamond detector, 30: rewritable field programmable gate array.

What is claimed is:

1. A radiation measurement apparatus comprising:
a radiation detector for detecting radiation and outputting an analog pulse signal that is a radiation detection signal;
an analog-to-digital converter for converting said analog pulse signal to a plurality of digital signals for each said analog pulse signal output from said radiation detector;
a digital signal integration apparatus for integrating said plurality of digital signals output from said analog-to-digital converter for each said analog pulse signal and obtaining an integrated value for each said analog pulse signal; and
a spectrum generation apparatus for generating a radiation energy spectrum using said integrated values and performing a quantitative analysis and an energy analysis of a radioactive nuclide detected by said radiation detector using information of said radiation energy spectrum.

2. The radiation measurement apparatus according to claim 1, comprising:
a threshold apparatus for discriminating said digital signals exceeding a threshold value among said plurality of digital signals output from said analog-to-digital converter for each said analog pulse signal, and outputting said plurality of discriminated digital signals to said digital signal integration apparatus for each said analog pulse signal.

3. The radiation measurement apparatus according to claim 2, comprising:
said analog-to-digital converter for converting, in one said analog pulse signal, five or more sample points of said one analog pulse signal to said digital signals.

4. The radiation measurement apparatus according to claim 3, comprising:
said digital signal integration apparatus for integrating said plurality of discriminated digital signals exceeding said threshold value from a point of time when said digital signals exceed said threshold value for each said analog pulse signal and obtaining said integrated values.

5. The radiation measurement apparatus according to claim 3, comprising:
said digital signal integration apparatus for integrating said plurality of discriminated digital signals existing for a predetermined period of time from a point of time when said digital signals exceed said threshold value for each said analog pulse signal and obtaining said integrated values.

6. The radiation measurement apparatus according to claim 3, comprising:
said threshold apparatus for obtaining a differentiation waveform of said corresponding analog pulse signal using said plurality of digital signals output from said analog-to-digital converter for each said analog pulse signal; and said digital signal integration apparatus for integrating said plurality of discriminated digital signals existing during a period of time from a point of time when said differentiation waveform exceeds a differentiation threshold value to a point of time of a second zero crossing point of said differentiation waveform crossing a ground level and obtaining said integrated values.

7. The radiation measurement apparatus according to claim 1, comprising:
a rewritable gate array including said threshold apparatus, said digital signal integrator, and said spectrum generation apparatus.

8. The radiation measurement apparatus according to claim 1, comprising:
a preamplifier for amplifying said analog pulse signal output from said radiation detector and outputting said amplified analog signal to said analog-to-digital converter, wherein said amplifier shapes said input analog pulse signal to an analog pulse signal having rise time equal to or shorter than a time range of said analog pulse signal.

9. The radiation measurement apparatus according to claim 1, wherein said radiation detector is any one of a semiconductor radiation detector, a scintillation detector, and a diamond detector.

10. The radiation measurement apparatus according to claim 9, wherein when said radiation detector is said scintillation detector, said analog-to-digital converter is an analog-to-digital converter having a sampling cycle within a range from 50 MHz to 2 GHz.

11. A method of measuring radiation, comprising steps of:
converting one analog pulse signal to a plurality of digital signals for each analog pulse signal output from a radiation detector detecting radiation;
integrating said plurality of digital signals for each said analog pulse signal and obtaining an integrated value for each said analog pulse signal;
generating a radiation energy spectrum using said integrated values; and
performing a quantitative analysis and an energy analysis of a radioactive nuclide for emitting said radiation detected by said radiation detector using information of said radiation energy spectrum.

12. The method of measuring radiation according to claim 11, comprising steps of:
discriminating said digital signals exceeding a threshold value among said plurality of digital signals for each said analog pulse signal; and
obtaining said integrated values using said plurality of discriminated digital signals for each said analog pulse signal.

13. The method of measuring radiation according to claim 12, comprising step of converting, in one said analog pulse signal, five or more sample points of said one analog pulse signal to said digital signals.

14. The method of measuring radiation according to claim 13, comprising step of integrating said plurality of discriminated digital signals exceeding said threshold value from a point of time when said digital signals exceed said threshold value for each said analog pulse signal and obtaining said integrated values.

15. The method of measuring radiation according to claim 13, comprising step of integrating said plurality of discriminated digital signals existing for a predetermined period of time from a point of time when said digital signals exceed said threshold value for each said analog pulse signal and obtaining said integrated values.

16. The method of measuring radiation according to claim 13, comprising steps of:
obtaining a differentiation waveform of said corresponding analog pulse signal using said plurality of digital signals for each said analog pulse signal, and
integrating said plurality of discriminated digital signals existing during a period of time from a point of time when said differentiation waveform exceeds a differentiation threshold value to a point of time of a second zero crossing point of said differentiation waveform crossing a ground level and obtaining said integrated values.

17. The method of measuring radiation according to claim 11, comprising steps of:
amplifying said analog pulse signal output from said radiation detector and
shaping said input analog pulse signal to an analog pulse signal having rise time equal to or shorter than a time range of said analog pulse signal in said amplification.

18. The method of measuring radiation according to claim 11, wherein any one of a semiconductor radiation detector, a scintillation detector, and a diamond detector is used as said radiation detector.

19. The method of measuring radiation according to claim 18, wherein when said scintillation detector is used as said radiation detector, conversion of said analog pulse signal to said plurality of digital signals is executed in a sampling cycle within a range from 50 MHz to 2 GHz.
